(19) United States
(12) Patent Application Publication
(10) Pub. No.: US 2008/0222557 A1
(43) Pub. Date: Sep. 11, 2008

(54) Method of displaying windows and display apparatus thereof

(75) Inventors: Yuichi Abe, Tokyo (JP); Yoichiro Sako, Tokyo (JP); Itaru Kawakami, Kanagawa (JP); Mitsuru Takehara, Tokyo (JP); Takatoshi Nakamura, Ibaraki (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/978,479

(22) Filed: Oct. 29, 2007

(30) Foreign Application Priority Data
Dec. 6, 2006 (JP) JP2006-328913

(51) Int. Cl. G06F 3/048

(52) U.S. Cl. 715/784; 715/804

(57) ABSTRACT

A method of displaying windows is disclosed. The method includes, when a first and second windows are displayed on a display screen of a display at the same time and display of the second window is changed with being interlocked with the first window by operating the first window, the steps of: forming a first data table in which input and output data forms are defined with respect to the first window; forming a second data table in which data forms transmitted from the first window to the second window are defined; receiving input to the first window from a user; performing processing of the first window according to the content of the received input; transmitting information of the processing in the first window to the second window associated in advance; and performing processing according to the transmitted information in the second window which received the transmission.

### CROSS REFERENCE TO RELATED APPLICATIONS

The present invention contains subject matter related to Japanese Patent Application JP 2006-328913 filed in the Japanese Patent Office on Dec. 6, 2006, the entire contents of which being incorporated herein by reference.

### BACKGROUND OF THE INVENTION

1. Field of the Invention

The invention relates to a method of displaying windows and a display apparatus thereof.

2. Description of the Related Art

The opportunity of coming into contact with a large amount of digital data increases along with development of digital processing techniques. For example, there are many opportunities to see or listen to digitized movies, books or music, to browse data of a digital camera personally taken, or to browse blogs on Internet.

For example, when information is displayed by a personal computer, the opportunity of allowing plural information to be displayed by associating the information with one another also increases. For example, opportunities to display photographs of a place based on position information, or to display a schedule or a blog so as to correspond to a date of a calendar are increasing.

FIG. 8 shows a display example when a blog is displayed on a display. Specifically, a numeral 10 denotes a display screen thereof, and a title 21 of the blog is displayed at an area 11 of the upper side in the example. An area 12 at the upper left in an area below the title area 11 is a profile area, where information 22 such as a profile of an owner (a producer) of the blog is displayed. In addition, an area 13 at the lower left is a calendar area, and a calendar 23 is displayed at the area 13.

In this case, a single month is shown at the calendar 23 on a monthly basis. In addition, numerals 23N showing years and months are displayed below the calendar area 13, and when clicking the numeral 23N, a month of the calendar 23 of a corresponding year and month will be displayed.

An area at the right side of the areas 12 and 13 is a blog window 14, where a blog article (an article to be a blog main content) 24 is displayed. The blog article 24 is the center of the blog, managed on a daily basis, in which events and the like can be written (posted) freely, for example, like a diary. In the case of FIG. 8, the blog article 24 includes plural images formed by taking pictures of fireworks at a fireworks display and the comment thereof.

A scroll bar 14S is displayed at the right side of the blog window 14. When the blog article 24 exceeds the height of the blog window 14, the scroll bar 14S is operated to allow the blog article 24 to be scrolled in a longitudinal direction and the whole article can be seen.

At the top of the outside of the blog window 14, a written date of the blog article 24 displayed on the blog window 14 and the dates before and after thereof are displayed by numerals 15.

When the blog article 24 is newly written, the blog article 24 newly written is linked with the written date in the calendar 23 as well as a numeral showing the written date of the blog article 24 in the calendar 23 is, for example, displayed in reverse video.

Therefore, when clicking the year-and-month numeral 23N of the calendar 23 to display the calendar 23 including a desired date and clicking the numeral of the date displayed in reverse video in the displayed calendar 23, the blog article 24 of the clicked date can be displayed on the blog window 14.

It should be noted that the title 21 to the blog article 24 are basic components of the blog, which are generally referred to as blog parts. The whole blog is configured by combining the blog parts 21 to 24.

As related art documents, for example, there are the following documents: JA-A-2002-041736 (Patent Document 1), JA-A-2004-021596 (Patent Document 2), JA-A-2005-018785 (Patent Document 3), and JA-A-2006-050176 (Patent Document 4).

### SUMMARY OF THE INVENTION

The above blog is suitable for selecting the welbog article 24 one by one, however, it is not suitable when one desires to perform zapping (to watch contents while continuously switching contents such as switching TV channels by a remote controller) by continuously switching the blog article 24.

The blog article 24 whose date is displayed in the calendar 23 can be accessed easily, however, since the calendar 23 is displayed on a monthly basis, for example, when watching a blog article 24 in a different year or a different month, it is necessary that the calendar 23 is changed and the year and month are adjusted to select the blog article 24. That is, it is necessary to click the numeral 23N many times when the user desires to change the year and month to be displayed.

Accordingly, when the past article is searched among many blog articles 24, it takes a lot of trouble. It is difficult to browse all articles when the number of blog articles 24 is large.

In addition, since only calendar 23 is displayed as date information, when a date of the target article is unknown, the user has to sequentially see the blog articles 24 at possible years. The above blog is also not suitable for the case that the user desires to reread the blog articles 24 written by now randomly through the whole.

The present invention addresses the above problems.

According to an embodiment of the invention, there is provided a method of displaying windows, when a first and second windows are displayed on a display screen of a display at the same time and display of the second window is changed with being interlocked with the first window by operating the first window, including the steps of forming a first data table in which input and output data forms are defined with respect to the first window, forming a second data table in which data forms transmitted from the first window to the second window are defined, receiving input to the first window from a user, performing processing of the first window according to the content of the received input, transmitting information of the processing in the first window to the second window associated in advance and performing processing according to the transmitted information in the second window which received the transmission.

According to the embodiment of the invention, for example, in the case of a blog, a blog article is changed with being interlocked by scrolling a chronology, which allows a target blog article to be watched.

### BRIEF DESCRIPTION OF THE DRAWINGS

FIG. 1 is a view showing an example of display according to an embodiment of the invention;

FIG. 2A to FIG. 2C are views showing examples of a part of display according to the embodiment of the invention;

FIG. 3 is a view showing an example of a personal computer usable in the embodiment of the invention;

FIG. 4A and FIG. 4B are flowcharts showing an example of a data processing method according to the embodiment of the invention;

FIG. 5 is a chart showing an example of a data table usable in the embodiment of the invention;

FIG. 6 is a chart showing an example of another data table usable in the embodiment of the invention;

FIG. 7A and FIG. 7B are block diagrams showing the data tables in a graphic manner; and

FIG. 8 is a view showing a display example for explaining the embodiment of the invention.

### DESCRIPTION OF THE PREFERRED EMBODIMENTS

### [1] Display Example of a Blog

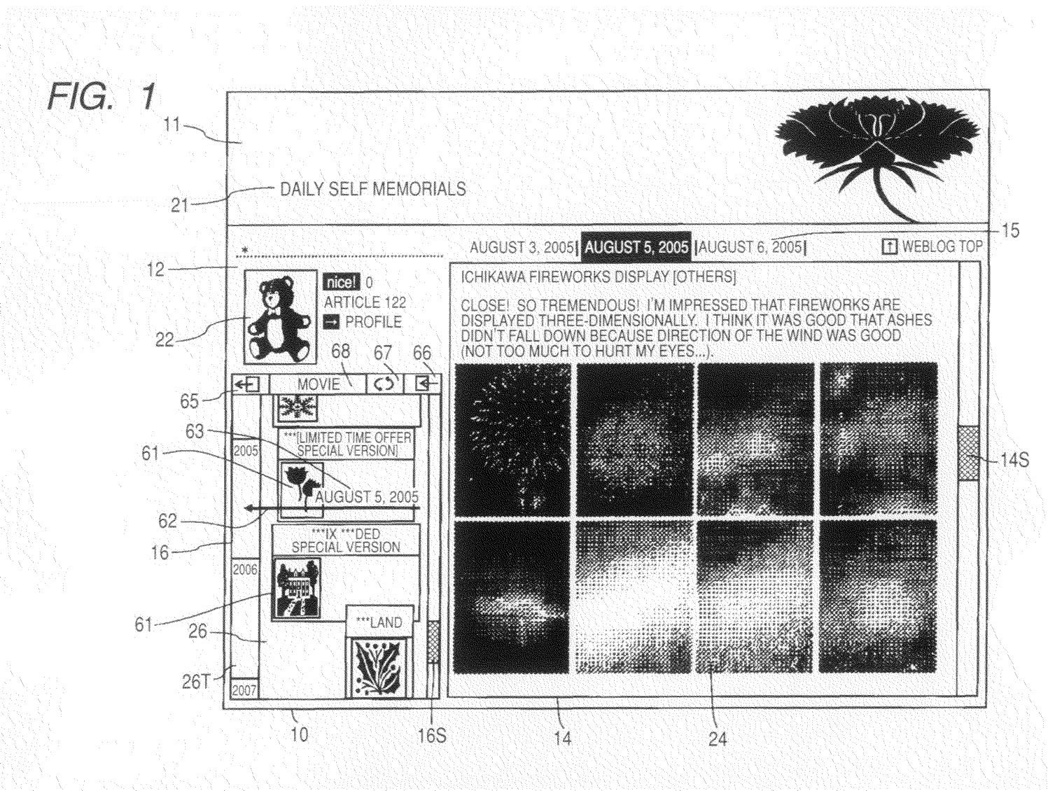

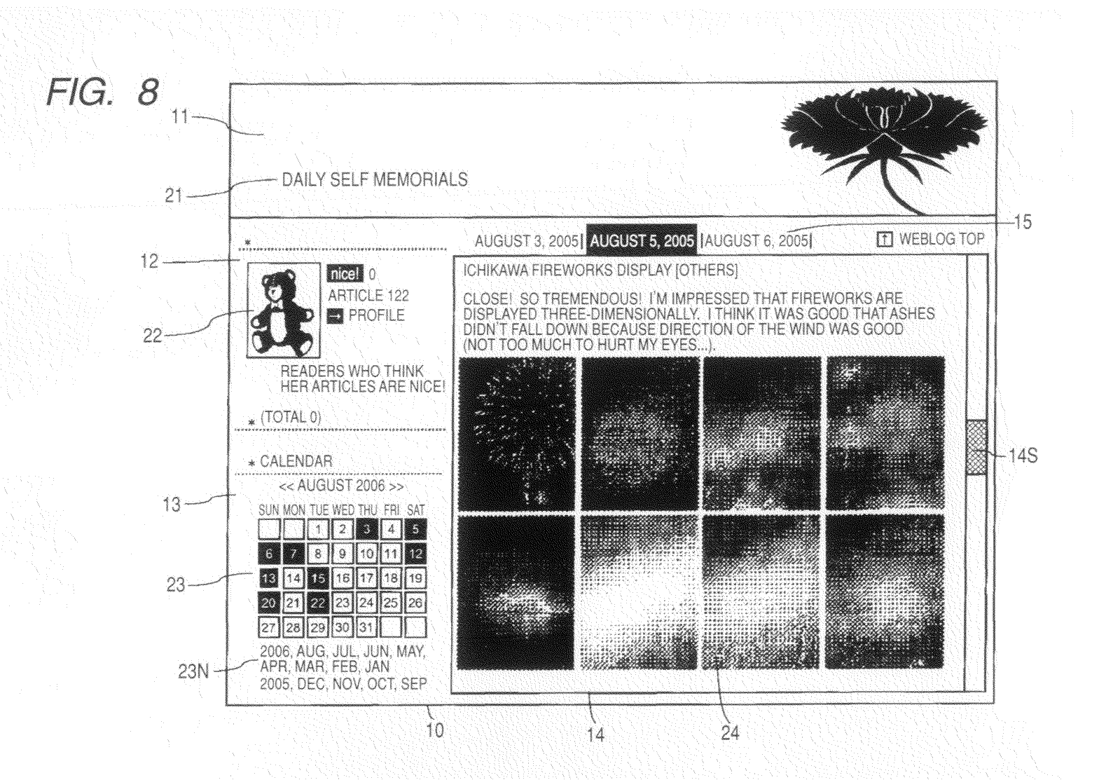

FIG. 1 is a display example of a blog according to an embodiment of the invention. In the example, blog parts are configured in the same manner as FIG. 8 excluding the calendar area 13 and the calendar 23 in FIG. 8.

Specifically, the title 21 of a blog is displayed at the title area 11 in an upper side of the display screen 10. In an area below the title area 11, the area 12 at the upper left is a profile area, where information 22 such as a profile of an owner of the blog is displayed. In an area below the title area 11, an area at the right side is the blog window 14, and the blog article 24 is displayed here. The blog window 14 and the blog article 24 are same as the ones explained in FIG. 8, in which the blog article 24 is scrolled in the longitudinal direction to see the whole article by, for example, operating the scroll bar 14S.

In the embodiment of the invention, a chronology window 16 is provided instead of the calendar area 13 in FIG. 8, and a chronology 26 for selecting a date is displayed in the chronology window 16. In this case, in the chronology window 16, a time axis 26T is displayed in the longitudinal direction at the left side, thumbnails 61 of events corresponding to dates shown by the time axis 26T are displayed in the order of time series at the center. In addition, a scroll bar 16S in the longitudinal direction is displayed at the right side of the chronology window 16.

The type of the chronology 26 displayed so as to correspond to date data can be selected from chronologies registered in a chronology creation/browse service by the blog owner. For example, a blog owner who is interested in foreign music can select a foreign music chronology or a blog owner who likes movies can select movie history.

A date pointer 62 indicating a date in the time axis 26T is displayed horizontally in the vicinity of the center of the chronology window 16 as well as a character string 63 of a date indicated by the date pointer 62 is displayed above the date pointer 62.

For example, when the scroll bar 16S of the chronology window 16 is moved in the longitudinal direction by operation of a mouse, the display contents of the chronology 26, namely, the thumbnails 61 are scrolled corresponding to the movement, along with the time axis 26T. However, the date pointer 62 does not move at this time. As a result, the date indicated by the date pointer 62 is changed corresponding to the scrolling of the chronology 26.

Then, the date shown by the character string 63 is changed corresponding to the change of the date indicated by the date pointer 62, and the change of the date is transmitted to the blog window 14, as a result, the display contents of the blog article 24 is changed with being interlocked with the change, and the blog article of the date is displayed. When there is not the blog article 24 corresponding to the date indicated by the date pointer 62, the blog article whose date is closest to the indicated date is displayed, or the fact that there is not a corresponding blog article is displayed.

Furthermore, at the top of the chronology window 16, a zoom-out button 65, a zoom-in button 66, a change button 67, and a title 68 are displayed. In this case, the zoom-out button 65 is the button for changing the time axis 26T displayed in the chronology window 16 in a direction in which the time axis 26T is displayed in a yearly basis, that is, for widening display intervals (date intervals) of thumbnails 61 in the chronology 26. The zoom-in button 66 is a button for changing the time axis 26T in a direction in which the time axis 26T is displayed in a monthly basis, that is, for narrowing display intervals (date intervals) of thumbnails 61 in the chronology 26.

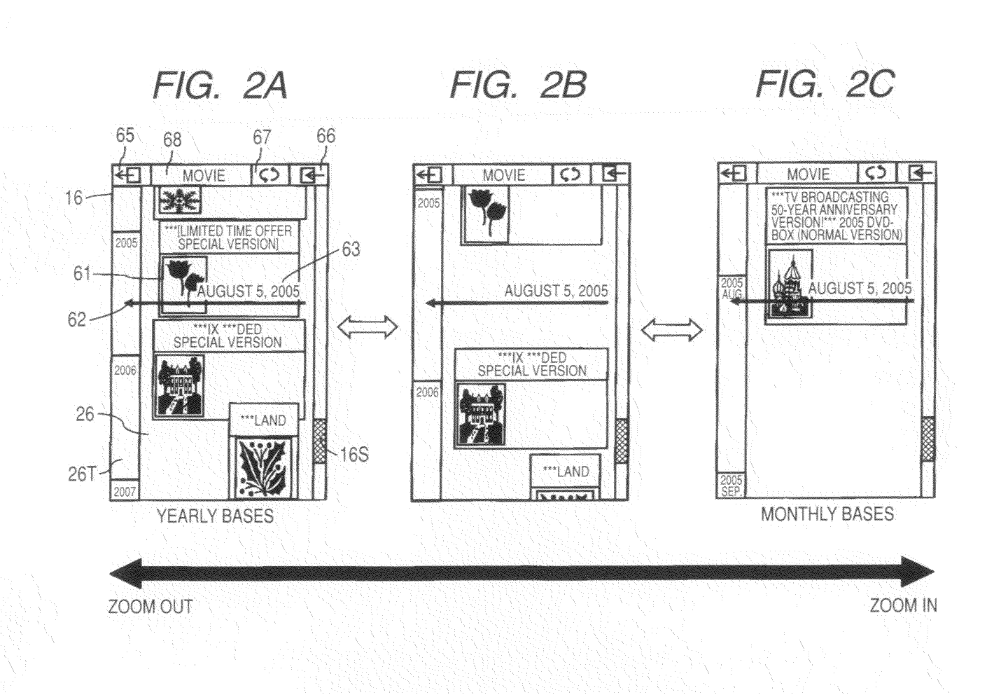

The change button 67 is a button for changing the content (kind) displayed in the chronology 26 and the title 68 is a character string showing the content of the chronology 26 displayed in the chronology window 16. In FIG. 1 (and FIGS. 2A to 2C) shows the case in which thumbnails 61 relating to movies in the chronology 26, therefore, “movie” is displayed in the title 68. The details of functions of the chronology 26 will be described later.

When the blog article 24 is newly written, the newly written blog article 24 and a corresponding date position in the chronology 26 are linked.

FIG. 2A to FIG. 2C show views in which parts of the chronology 26 displayed in the chronology window 16 are picked up and shown. In this case, the chronology 26 by a “chronology creation/browse service” can be used for the creation of the chronology 26. The “chronology creation/browse service” is a web service in which a personal history can be created by arranging personal background, music listened to in the past, comics read in the past, things purchased in the past, memorable events and the like in time series to remember the past with nostalgia.

For example, the zoom-out button 65 is clicked to zoom out to the maximum, the time axis 26T of the chronology 26 is displayed on a yearly basis and thumbnails 61 are also displayed on a yearly basis as shown in FIG. 2A. That is, a wider range of dates is displayed in the chronology 26 such as when zooming out by a zoom lens. FIG. 2A is a display example of a state of zooming out to the maximum. In this state, a scroll amount of the chronology 26 with respect to operation of the scroll bar 16S is large.

On the other hand, when the zoom-in button 66 is clicked to zoom in to the maximum, the time axis 26T of the chronology 26 is displayed on a monthly basis and thumbnails 61 are also displayed on a monthly basis as shown in FIG. 2C. That is, a narrower range of dates is enlarged-displayed in the chronology 26 such as when zooming in by a zoom lens. FIG. 2C is a display example of a state of zooming in to the maximum. In this state, the scroll amount of the chronology 26 with respect to operation of the scroll bar 16S is small.

When the zoom-out button 65 or the zoom-in button 66 is clicked, the chronology 26 is in an intermediate zooming state, for example, as shown in FIG. 2B. The scroll amount of the chronology 26 with respect to the scroll bar 16S will be the intermediate size. Even when performing the above zooming, the date pointer 62 does not move. Therefore, the scroll amount of the chronology 26 with respect to an operation amount when the scroll bar 16S is operated can be changed by the zoom buttons 65, 66.

Though not shown, when the change button 67 is clicked, the content in the thumbnails 61 and the title 68 in the chorology 26 is sequentially changed, for example, from “movie” to “music” or “news” and the like.

### [2] Example of Use

For example, when a specific article 24 is searched, first, the zoom-out button 65 is clicked to zoom out (the state of FIG. 2A or FIG. 2B), next, the scroll bar 16S is operated to scroll the chronology 26 to around position where the target article 24 is placed. Then, when the zoom-in button 66 is clicked to zoom in (the state of FIG. 2B or FIG. 2C) and the scroll bar 16S is operated to scroll the chronology 26, the target blog article 24 can be displayed.

When the blog article 24 is searched, it can be narrowed down from related thumbnails 61 to reach the target blog article 24. Therefore, the search of the target blog article 24 becomes easy.

In addition, when date intervals of the time axis 26T are made wider moderately as shown in FIG. 2B and the scroll bar 16S is operated in that state, the blog article 24 can be continuously switched, namely, the zapping can be performed. Date intervals of the blog articles 24 zapped at that time can be arbitrarily set and also can be changed by zoom buttons 65, 66 in the middle of the zapping.

According to the above blog system, it is possible to search or browse the blog article 24 in various methods. For example, when a personal history showing one's background, events experienced by oneself can be searched and browsed easily.

In the case that the blog system is published on a web page, it is possible to share memories and nostalgia with other users by receiving comments from other users or comparing the chronology with the ones created by other users.

### [3] Example of Hardware

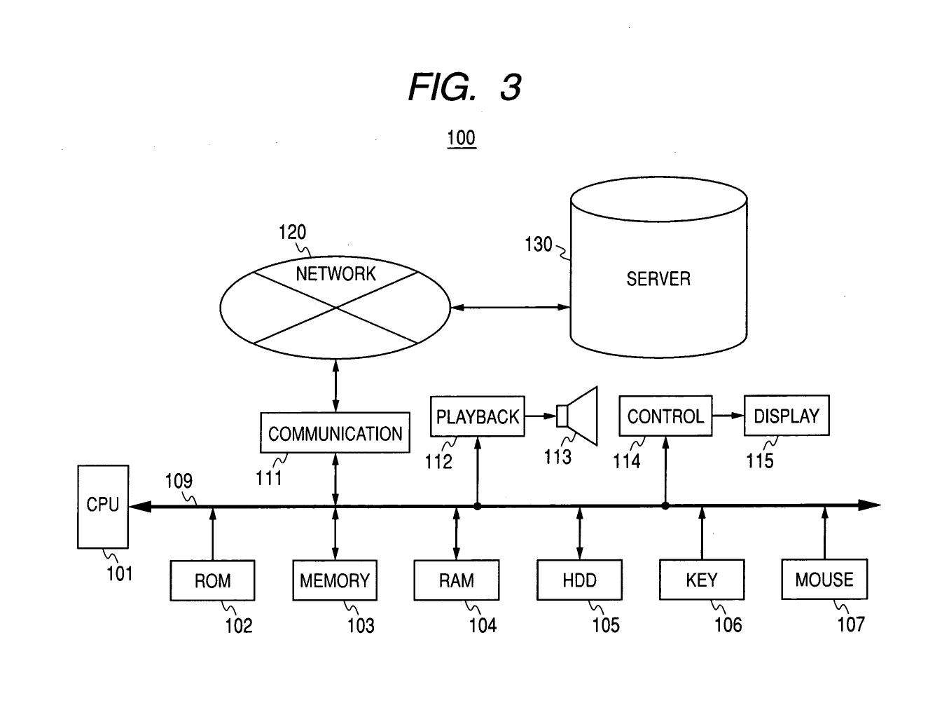

FIG. 3 is an example of a case in which the above blog system is realized on a local personal computer. That is, a personal computer 100 has the same configuration as a general-purpose computer, including a CPU 101, a ROM 102, a nonvolatile memory 103 and a RAM 104.

In this case, the CPU 101 executes various programs and BIOS and basic data executed by the CPU 101 are written in the ROM 102 and the memory 103. The RAM 104 will be a work area when the CPU 101 executes programs, and these memories 102 to 104 are connected to the CPU 101 through a system bas 109.

In addition, a hard disc drive 105 is connected to the system bus 109 as a large-capacity storage and a keyboard 106 and a mouse 107 are connected to the system bus 109 as user interfaces, particularly, as a character input device and a pointing device. In the hard disc drive 105, software such as OS, browsers for browsing web pages is installed.

A communication interface circuit 111 is connected to the system bus 109, and the personal computer 100 is connected to an external network, for example, the Internet 120 through the communication interface circuit 111. A server 130 is further connected to the Internet 120, and various data that can be used for creating the chronology 26 is stored in the server 130.

The data stored in the server 130 is downloaded through the Internet 120, and further, through the communication circuit 111 and stored in the hard disc drive 105.

The personal computer 100 is also provided with an audio playback circuit 112 and a display control circuit 114, which are also connected to the system bus 109. The audio playback circuit 112, when digital audio data is supplied thereto, performs decode processing such as MP3 if necessary, and further, the digital audio data is D/A converted into analog audio signals, which are supplied to a speaker 113.

Furthermore, the display control circuit 114 includes a video RAM though not shown. Display data is supplied to the video RAM as well as read out repeatedly at a predetermined cycle to be converted into video signals, and the video signals are supplied to a display 115 to display images as shown in FIG. 1 and FIGS. 2A to 2C.

Therefore, the blog system explained in [1] and [2] can be realized in the personal computer 100. In the case of publishing the blog explained in [1] and [2] on web pages provided by ISPs, it can be published in the same way only by allowing the user interfaces such as the keyboard 106, the mouse 107 and the display 115 to be user interfaces of personal computers of clients (blog owners or blowsers).

[4] A Method of Interlocking the Chronology with the Blog article

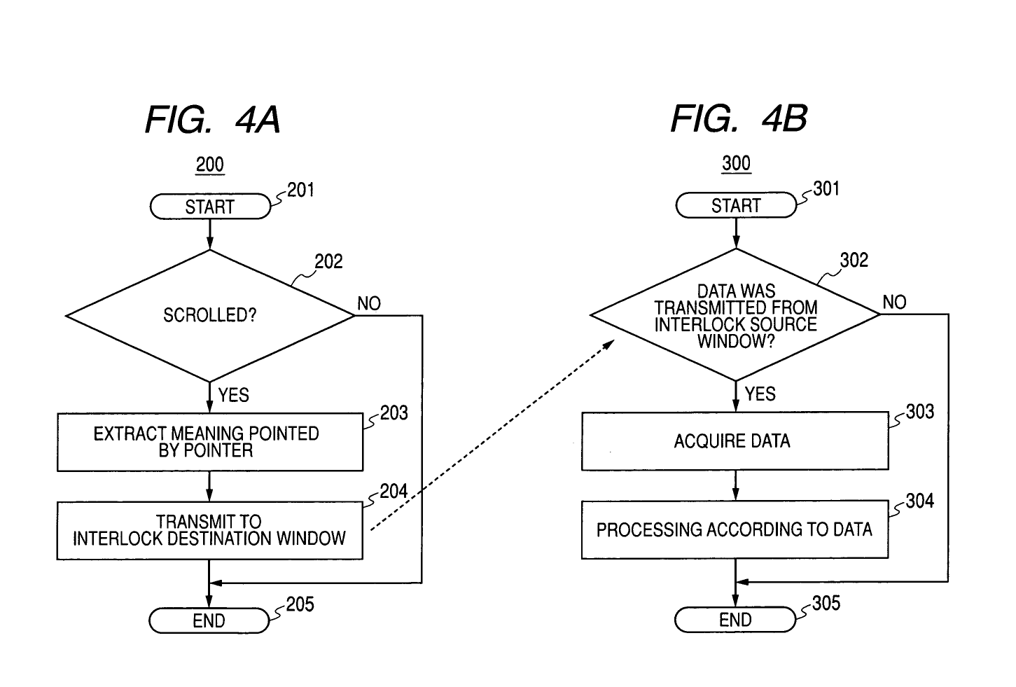

As described above, when the scroll bar 16S is operated and the chronology 26 is scrolled, the blog article 24 is changed with being interlocked with the scroll, which can be realized by, for example, routines 200, 300 shown in FIGS. 4A and 4B. The routines 200, 300 show only the interlocked processing, however, the routine 200 is executed at a predetermined cycle at an interlock source and the routine 300 is executed at a predetermined cycle at an interlock destination.

That is, for example, in the personal computer 100, processing of the CPU 101 starts from Step 201 of the routine 200. Next, in Step 202, whether the scroll bar 16S was operated or not is determined, and when the scroll bar 16S is not operated, the process proceeds to from Step 202 to Step 205 and the routine 200 ends. Therefore, when the scroll bar 16S is not operated, nothing is executed.

However, in Step 202, the scroll bar 16S is operated, the process proceeds from Step 202 to Step 203, and in Step 203, a date (year, month and day) indicated by the date pointer 62 is detected and the detected result is transmitted to a window to be an interlock destination in Step 204. Then, the processing according to the scroll bar 16S, namely, data processing which changes the contents of the chronology 26 is performed and the routine 200 ends in Step 205.

According to the routine 200, every time the scroll bar 16S is operated, data of the date indicated by the date pointer 62 is transmitted to a window which will be the interlock destination. In the case that the window to be the interlock destination is a window which is a different application from the interlock source window, or a window on a different personal computer 100, data of the date detected in Step 203 is transmitted to the server 130. That is, the data is transmitted to a window which is a different application or a window on a different personal computer 100 through the server 130.

On the other hand, in the interlock destination, the process of the CPU 101 starts from Step 301 in the routine 300. Next, in Step 302, data transmitted from Step 204 in the routine 200, namely, whether data of the date indicated by the date pointer 62 has been transmitted or not is determined, and when it has not been transmitted, the process proceeds from Step 302 to Step 305 to end the routine 300. Therefore, when the scroll bar 16S is not operated in the personal computer 100, nothing is executed and the display of the display 115 is not changed.

However, in Step 302, data of the date indicated by the date pointer 62 is transmitted, the process proceeds from Step 302 to Step 303, and in Step 303, the transmitted date, namely, the date indicated by the date pointer 62 is acquired.

Then, in Step 304, processing in which the blog article 24 of the blog window 14 is changed to the corresponding contents according to the acquired date is performed, after that, the routine 300 ends in Step 305. Therefore, when Step 304 is executed, the chronology 26 is scrolled as well as the blog article 24 is also changed in the display screen 10 of the personal computer 100.

According to the routines 200, 300, every time the scroll bar 16S is operated, the chronology 26 is scrolled and the blog article 24 is changed to a corresponding article.

### [5] Interlock of Windows

The case in which the chronology 26 is displayed in the window 16 is described above, the content displayed in the window 16 may be the one which can be associated with and interlocked with the blog article 24, not limited to the chronology 26. For example, it is possible to display a map in the window 16 and articles relating to the displayed map are displayed in the window 14. That is, the window 16 is made to be an input window and the window 14 is made to be an output window thereof.

[5-1] Example of a Data Table which Defines the Windows

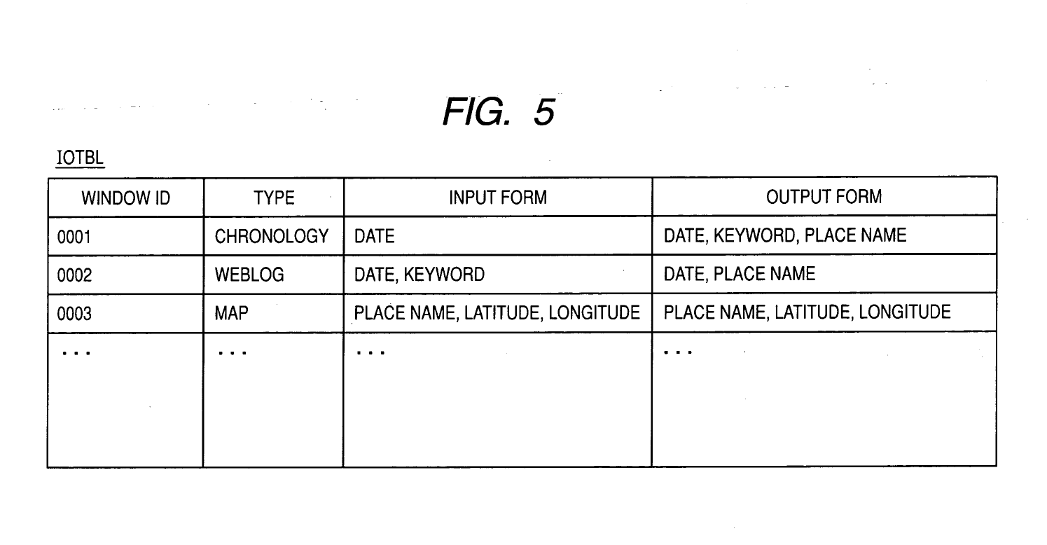

FIG. 5 shows an example of a data table IOTBL for realizing the above window form. That is, in FIG. 5, the data table IOTBL includes “window ID”, “type”, “input form”, and “output form”. The window ID shows identification codes for identifying the content to be displayed on the window 16 (the chronology 26 in the above case), and the type shows types of the contents displayed on the window 16. The first line in FIG. 5 corresponds to the case in FIG. 1 and FIGS. 2A to 2C, which is the case in which the window ID is “0001” and the type is “chronology”.

The input form shows data forms inputted from another window, and the output form shows data forms which can be outputted to another window. That is to say, respective windows can be an interlock source window and can be also an interlock destination window. The respective windows can be also the both. Since the first line in FIG. 5 corresponds to the case of FIG. 1 and FIGS. 2A to 2C, the input form is “date” and the output form is “date, keyword, place name”, therefore, the line indicates that information of “date” can be inputted from another window, and information of “date, keyword, place name” can be outputted to another window.

Specifically, the “date” information is acquired from the interlock source window and the chronology based on the date information is displayed. When the chronology 26 is scrolled, titles, place names and the like of events displayed by the dates or the chronology can be outputted to the interlock destination.

### [5-2] Example of a Data Table for Associating Windows

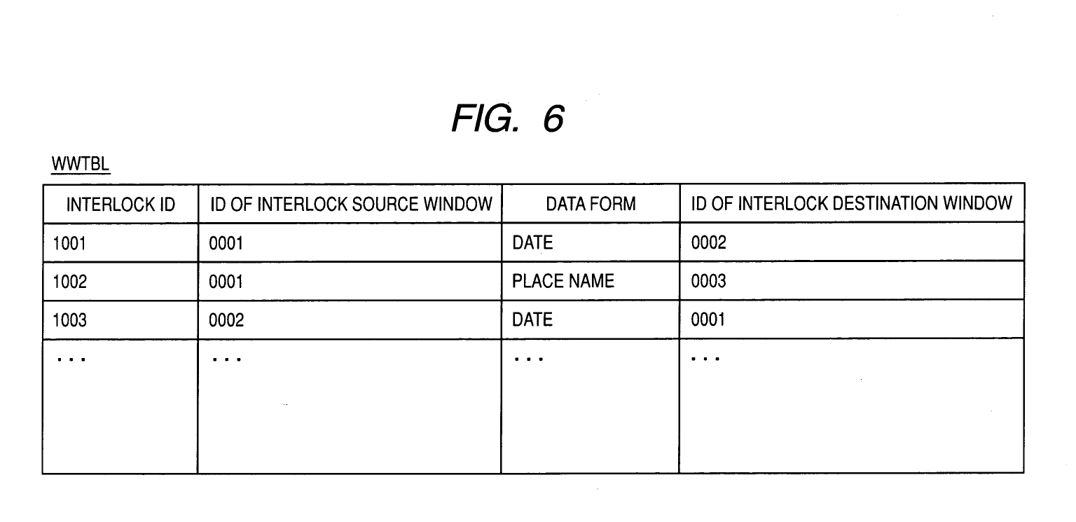

FIG. 6 shows an example of a data table WWTBL which defines interlock relationship between the window 16 and the window 14. The data table WWTBL includes “interlock ID”, “ID of interlock source window”, “data form” and “ID of interlock destination window”.

The interlock ID shows identification codes for uniquely designating interlock data and ID of the interlock source window shows identification codes assigned to windows to be interlock sources. The data form shows data forms transmitted from interlock source windows to interlock destination windows, and the ID of interlock destination window shows identification codes of windows to be interlock destinations.

For example, the first line of FIG. 6 shows that interlock data having an interlock ID “1001” transmits data having the data form “date” from the window having the ID of the interlock source window “0001” to the window having the ID of the interlock destination window “0002”.

### [5-3] Example of Using Tables IOTBL, WWTBL

When combining [5-1] with [5-2], “date” data is transmitted to the “blog” window by the “chronology” window being operated, and processing based on the date can be performed in the blog window as described above.

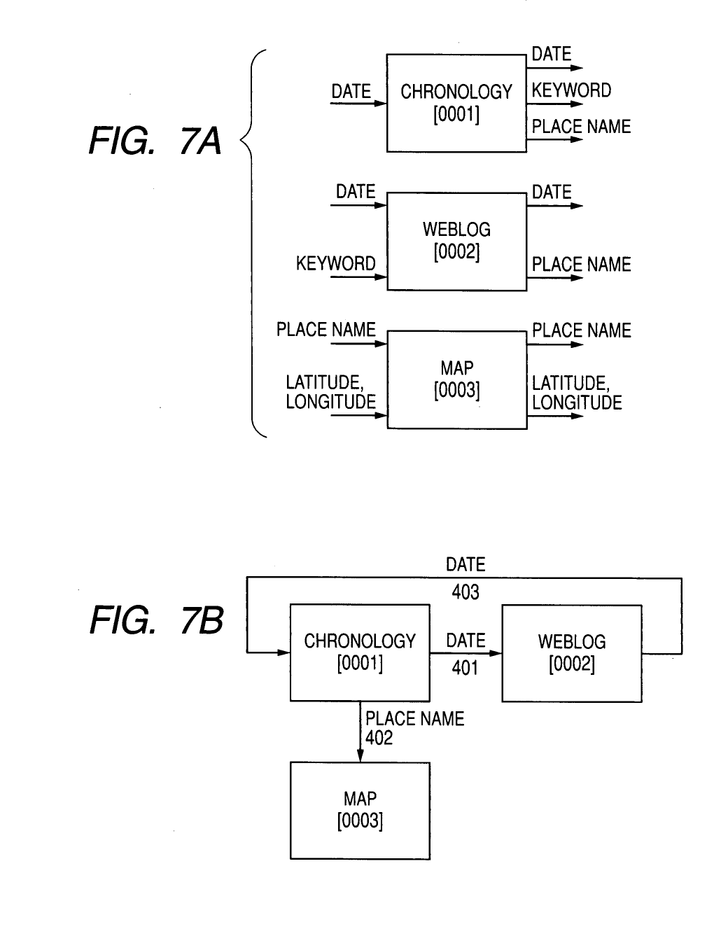

FIG. 7A shows the data table IOTBL in FIG. 5 in a graphic manner, and FIG. 7B shows the data table WWTBL in FIG. 6 in a graphic manner. Numerals inside [ ] show window IDs in FIG. 5.

In an example of FIG. 7B, when the “chronology” window is operated, “date” data is transmitted to the “blog” window as shown by a numeral 401, and “place name” data is transmitted to the “map” window as shown by a numeral 402. Then, in the “blog” window and the “map” window, processing is performed based on the transmitted data, respectively.

For example, a blog article of the transmitted date is displayed in the “blog” window, and a map based on the transmitted place name is displayed in the “map” window. When the “blog” window is operated, the “date” data is transmitted to the “chronology” window as shown in a numeral 403. Then, a chronology based on the transmitted date is displayed in the “chronology” window.

A blog owner can easily capture interlock relationship between windows visually by graphically displaying graphic figures as described above, and the blog owner can also easily change interlock relationship by changing the input and output of windows. Moreover, the blog owner can easily capture as well as easily define interlock relationship of windows, therefore, a blog page can be easily customized according to individual preference.

It is preferable that the interlock between windows as shown in FIG. 6 is created by an administrator of a blog site in advance, or it is preferable that a blog owner dynamically associates windows. The editing of interlock relationship as shown in FIG. 7A and FIG. 7B can be changed in an administrator page of the blog.

### [6] Summary

According to the above blog system, blog articles of interlock destination windows can be continuously browsed by scrolling the chronology of the window which is the interlock source. In addition, a status of an interlock destination window can be changed easily and at high speed by zooming or scrolling the chronology of an interlock source window.

Furthermore, the interlock relationship between windows can be visually captured. Also, the interlock relationship between windows can be graphically edited.

### [7] Others

In the above description, the content (kind) of the chronology 26 can be movie history, foreign music and the like. Also, for example, personal history showing background of oneself or a private chronology including images and the like taken in the past can be created to be a chronology for selecting dates.

By interlocking the scrolled results of the chronology 26 for selecting dates with the browsing of the blog articles 24 as described, the blog articles 24 stored for over long periods can be easily browsed and the blog windows 24 can be zapping-displayed easily, as a result, the blog window 16 to be the interlock source can be, for example, the blog form or the map form in addition to the chronology form.

The case in which the operation results of the chronology 26 for selecting dates are transmitted to the blog window 14 was described in the above, it is also preferable to apply a configuration in which, when browsing the blog article 24, the chronology 26 corresponding to the article is automatically displayed by allowing the blog article 24 to be the interlock source and allowing the chronology window 16 to be the interlock destination in the inverse manner of the above. For example, in the case that the display of the window 16 is the map, the blog article 24 relating to the displayed place name can be displayed when the map is scrolling-displayed.

It is also preferable that the blog article 24 is changed when the chronology 26 or the map is operated by defining plural windows 16 as interlock sources, conversely, that the map and the blog article are changed when the chronology 26 is operated by defining plural windows 14 as interlock destinations, furthermore, it is preferable that the chronology and the blog are interlocked with each other by associating the interlock source window and the interlock destination window with each other.

### [List of Abbreviation]

BIOS: Basic Input/Output System

CPU: Central Processing Unit

D/A: Digital to Analog

ID: Identification

ISP: Internet Service provider

OS: Operating System

RAM: Random Access Memory

ROM: Read Only Memory

Web: World Wide Web

Blog: Weblog

It should be understood by those skilled in the art that various modifications, combinations, sub-combinations and alterations may occur depending on design requirements and other factors insofar as they are within the scope of the appended claims or the equivalents thereof.

1. A method of displaying windows, when a first and second windows are displayed on a display screen of a display at the same time and display of the second window is changed with being interlocked with the first window by operating the first window, comprising:
forming a first data table in which input and output data forms are defined with respect to the first window;
forming a second data table in which data forms transmitted from the first window to the second window are defined;
receiving input to the first window from a user;
performing processing of the first window according to content of the input;
transmitting information of the processing in the first window to the second window associated in advance; and
performing processing according to the information in the second window in response to the transmission.

2. The method of displaying windows according to claim 1,
wherein the first window which receives the input from the user performs scrolling processing and continuously outputs data to the second window in the data form based on the second data table.

3. The method of displaying windows according to claim 1,
wherein, in the first window which receives input from the user, a scroll amount with respect to an operation amount of scrolling is variable.

4. The method of displaying windows according to claim 1,
wherein the association between the first and second windows are defined according to the data forms as processing results in the window.

5. The method of displaying windows according to claim 1,
wherein the association between the first and second windows is shown by writing identification information identifying the first and second windows respectively and information types transmitted from the first window to the second window in the second data table.

6. A display apparatus of windows in which a first and second windows are displayed on a display screen of a display at the same time and display of the second window is changed with being interlocked with the first window by operating the first window, comprising:
a first storage medium storing a first data table defining input and output data forms with respect to the first window;
a second storage medium storing a second data table defining data forms transmitted from the first window to the second window;
a reception means for receiving input from a user with respect to the first window; and
a processing means for performing the first and second windows, and
wherein processing means performs processing of content of the input in the reception means in accordance with the first data table, transmits information of the processing in the first window to the second window associated in advance by the second data table and performs processing according to the information in the second window in response to the transmission.

7. A display apparatus of windows in which a first and second windows are displayed on a display screen of a display at the same time and display of the second window is changed with being interlocked with the first window by operating the first window, comprising:
a first storage media storing a first data table defining input and output data forms with respect to the first window;
a second storage media storing a second data table defining data forms transmitted from the first window to the second window;
a reception unit configured to receive input from a user with respect to the first window; and
a processing unit configured to perform the first and second windows, and
wherein the processing unit performs processing of content of the input in the reception unit in accordance with the first data table, transmits information of the processing in the first window to the second window associated in advance by the second data table and performs processing according to the information in the second window which received the transmission.
